(19) United States
(12) Patent Application Publication
(10) Pub. No.: US 2015/0233603 A1
(43) Pub. Date: Aug. 20, 2015

(54) HEAT TRANSFER UNIT

(71) Applicant: Hubert W. Jenkins, Innisfail (CA)

(72) Inventor: Hubert W. Jenkins, Innisfail (CA)

(21) Appl. No.: 14/181,854

(22) Filed: Feb. 17, 2014

(51) Int. Cl. F24H 1/16; B23P 15/26

(52) U.S. Cl. CPC F24H 1/162; B23P 15/26

(57) ABSTRACT

A heat transfer unit and kit therefore is disclosed herein. The heat transfer unit includes a heater. The heat transfer unit also includes a gasket operable to sealingly engage the manifold along a first perimeter. The gasket includes an aperture defining a cavity at least partially surrounded by the perimeter and partially enclosed by said heater. The heat transfer unit also includes a quantity of heat transfer material positionable in the cavity. The quantity of heat transfer material is dispensable in liquid form into the cavity and curable to solidify while disposed in the cavity.

### BACKGROUND OF THE INVENTION

1. Field of the Invention

The invention relates to a unit to conductively transfer heat to a structure to be heated.

2. Description of Related Prior Art

U.S. Pat. No. 7,918,203 discloses a MOTOR OIL HEATING SYSTEM, PRODUCT AND METHOD. A motor oil heating system for a vehicle comprising one or more solar panels comprised of one or more photovoltaic cells; one or more heaters thermally coupled to the motor oil, wherein the solar panels are electrically coupled to the heaters and power the heaters based on a voltage generated by the solar panel such that the heaters warm the engine oil.

### SUMMARY OF THE INVENTION

In summary, the invention is a heat transfer unit. The heat transfer unit includes a heater. The heat transfer unit also includes a gasket operable to sealingly engage the manifold along a first perimeter. The gasket includes an aperture defining a cavity at least partially surrounded by the perimeter and partially enclosed by the heater. The heat transfer unit also includes a quantity of heat transfer material positionable in the cavity. The quantity of heat transfer material is dispensable in liquid form into the cavity and curable to solidify while disposed in the cavity.

### BRIEF DESCRIPTION OF THE DRAWINGS

The detailed description set forth below references the following drawings:

FIG. 1 is an illustration of the components of a kit according to one embodiment of the broader invention;

FIG. 2 is a side view of the kit assembled to a structure to be heated;

FIG. 3 is a top view showing an interior of a heater according to one embodiment of the broader invention;

FIG. 4 is a top view of a gasket positioned on a heater in one embodiment of the broader invention;

FIG. 5 is a first partial cross-sectional view of one embodiment of the broader invention assembled to a structure to be heated;

FIG. 6 is a second partial cross-sectional view of another embodiment of the broader invention assembled to a structure to be heated; and

FIG. 7 is a third partial cross-sectional view of another arrangement.

### DETAILED DESCRIPTION OF EXEMPLARY EMBODIMENTS

A plurality of different embodiments of the invention is shown in the Figures of the application. Similar features are shown in the various embodiments of the invention. Similar features have been numbered with a common reference numeral and have been differentiated by an alphabetic suffix. Also, to enhance consistency, the structures in any particular drawing share the same alphabetic suffix even if a particular feature is shown in less than all embodiments. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

The invention, as demonstrated by the exemplary embodiments described below, can provide a heat transfer to direct heat to or from another structure. The other structure can be an oil pan or hydraulic fluid tank or any other structure to be heated. The exemplary embodiments disclosed herein are relatively easy to install and enjoy a long life. The exemplary embodiments disclosed and others not disclosed can efficiently heat and cool structures in relatively short periods of time. One or more particular embodiments of the broader invention can be used with a combustion engine, diesel-fired equipment, and/or circulating electrical heater or equipment.

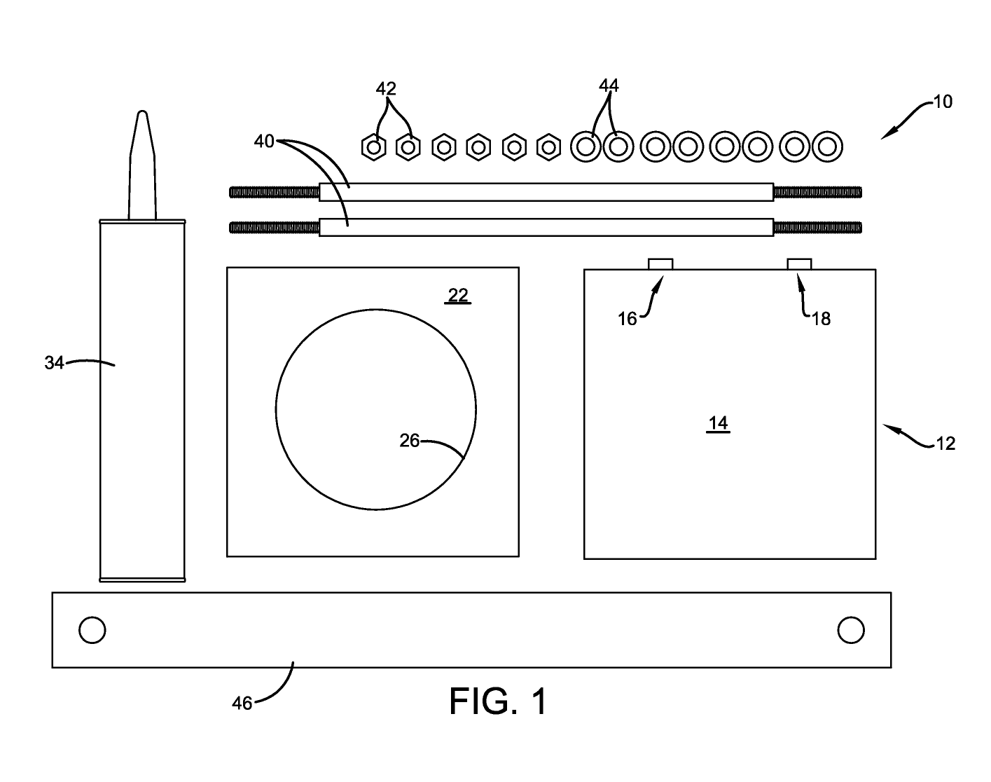

FIG. 1 shows the components of an exemplary kit for an embodiment of a heat transfer unit 10. The exemplary heat transfer unit 10 includes a heater 12. The exemplary heater 12 is a manifold 14 having an inlet 16 and an outlet 18. The inlet 16 and the outlet 18 are in fluid communication with one another. A thermal fluid for exchanging thermal energy can enter the manifold 14 through the inlet 16 and exit the manifold 14 through the outlet 18.

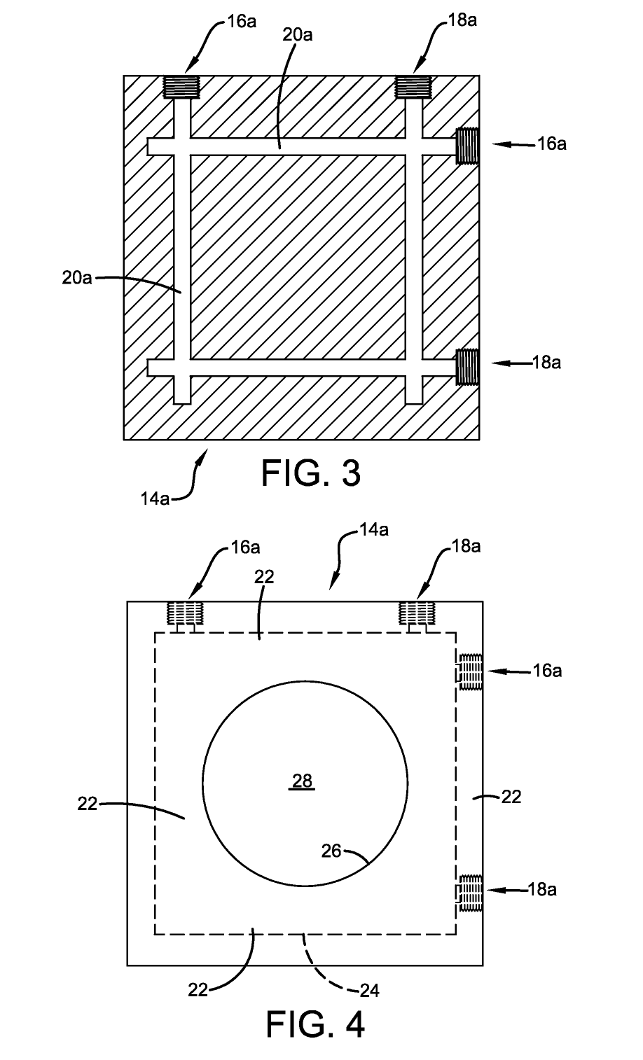

FIG. 3 shows the interior of one embodiment of a manifold 14a. The manifold 14a has various inlets 16a and outlets 18a in fluid communication with one another. One or more inlets and/or outlets could be capped if not in use. A torturous path 20a extends between the inlet 16a and the outlet 18a. The torturous path 20a enhances the transfer of thermal energy over a straight path. However, it is noted that other embodiments of the manifold 14 can include a straight path for thermal fluid. It is also noted that other forms of heater can be used in other embodiments of the invention. For example, an electric heater can be used in one or more alternative embodiments of the invention.

The exemplary heat transfer unit 10 also includes a gasket 22 operable to sealingly engage the heater 12 along a first perimeter 24. FIG. 4 is a top view of a gasket 22 positioned on the heater 12. The gasket 22 includes an aperture 26 defining a cavity 28 at least partially surrounded by the first perimeter 24. The exemplary cavity 28 is partially enclosed by the heater 12 and the aperture 26. The exemplary cavity 28 is open at the top. The gasket 22 can be formed of neoprene or any other elastically deformable material.

The exemplary heat transfer unit 10 also includes a quantity of heat transfer material positionable in the cavity 28. FIG. 1 shows a container 34 containing an exemplary quantity of heat transfer material. The quantity of heat transfer material is dispensable in liquid form into the cavity 28 and curable to solidify while disposed in the cavity 28. The quantity of heat transfer material hardens and becomes a solid as a result of curing. Any curable material can be used in various embodiments of the invention. One exemplary material is Thermon Cement made by the Thermon Manufacturing Company in San Marcos, Tex.

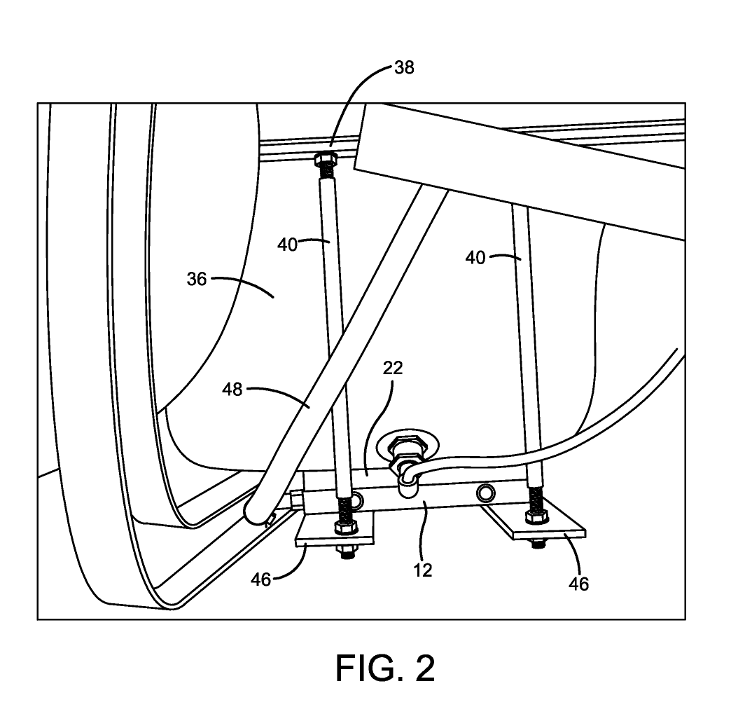

Embodiments of the invention can be applied to heat a structure. FIG. 2 is a side view of the kit assembled to a structure 36 to be heated. Structures that can be heated include, but are not limited to, a fuel tank, an oil pan, and a hydraulic fluid reservoir.

In one exemplary method of using the heat transfer unit kit, a first set of fasteners connecting the structure 36 to a frame 38 can be removed. The first set of fasteners is not shown in the Figures, but could be threaded bolts. It is noted that the first set of fasteners can be less than all of the fasteners used to connect the structure 36 to the frame 38.

The heater 12 and the gasket 22 and the quantity of heat transfer material can then be located against the structure 36 to be heated. The structure 36 and the heater 12 and the gasket 22 and the quantity of heat transfer material can then be connected to the frame 38 with a second set of fasteners using the same attachment points as the original set of fasteners. FIG. 2 shows an exemplary arrangement. The quantity of heat transfer material can cure after the assembly so that the surface of the cured heat transfer material mates precisely with the outer surface of the structure 36.

FIG. 1 shows that an exemplary kit can include a plurality of fasteners operable to mount the manifold 14 and the gasket 22 with respect to a structure 36 to be heated. The fasteners include threaded bolts 40 and spacing nuts 42 and washers 44 to accommodate the assembly of the kit to the structure 36 using the same attachment points as the original set of fasteners. A plate 46 can support the underside of the heater 12 and have apertures to respectively receive the plurality of fasteners. FIG. 2 shows one side of the mounting arrangement and the opposite can be similar. The fasteners can be tightened to sealing engage the gasket 22 along a second perimeter, wherein the first perimeter 24 and the second perimeter are on opposite sides of the gasket 22. The gasket 22 can be elastically compressed. Fluid lines 48 for directing thermal fluid to the heater 12 can be connected as shown in FIG. 2.

In one or more embodiments of the broader invention, the cavity 28 can be filled and without void after assembly of the heat transfer unit 10 to the structure to enhance the conductive transfer of thermal energy. In one or more embodiments of the broader invention, the cavity 28 can be filled with the quantity of heat transfer material. In one or more embodiments of the broader invention, the cavity 28 can be filled with the structure 36 and the quantity of heat transfer material and without void.

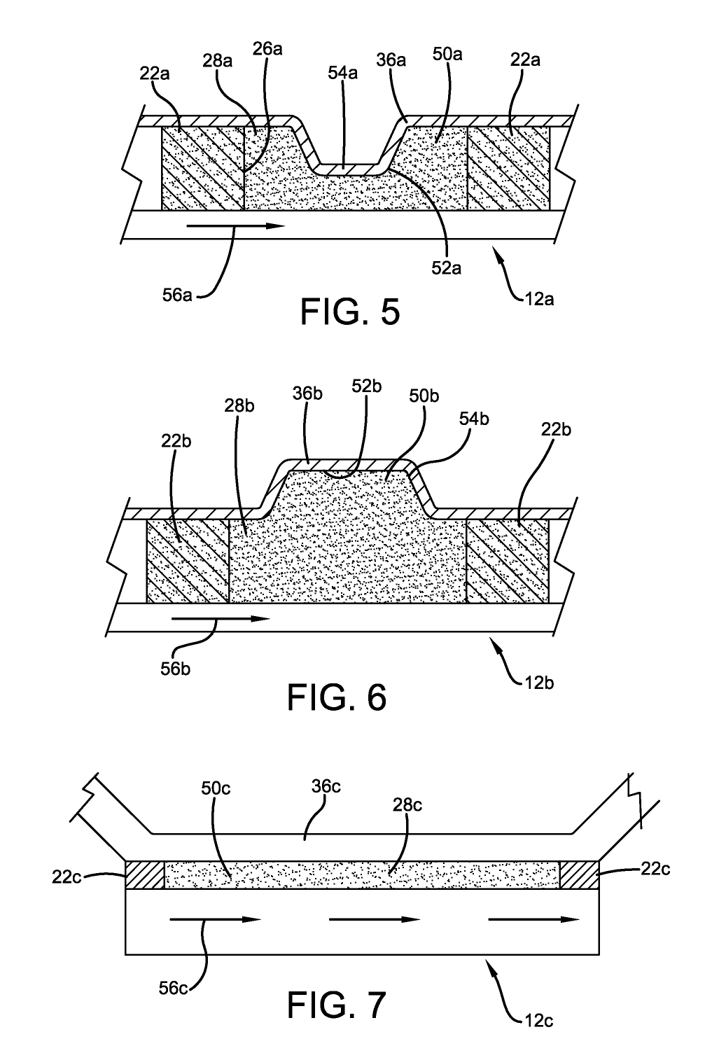

In one or more embodiments of the broader invention, a heat transfer unit can be located against a non-planar surface of a structure to be heated. FIG. 5 is a partial cross-sectional view of a first embodiment of the broader invention assembled to a structure to be heated. A heater 12a is mounted with respect to a structure 36a. A thermal fluid, referenced schematically at 56a, is passing through the heater 12a. A gasket 22a is disposed between the heater 12a and the structure 36a. A cavity 28a is defined by and between the structure 36a, the gasket 22a, and the heater 12a. The cavity 28a is filled with a cured and solid heat transfer material referenced at 50a.

The structure 36a has a non-planar surface 52a contacting the heat transfer material 50a. The surface 52a defines a protuberance 54a. The protuberance 54a is inserted into the cavity 28a during the step of locating the heater 12a, the gasket 22a, and the uncured quantity of heat transfer material. In this embodiment, the cavity 28a was less than fully filled with the uncured quantity of heat transfer material. The structure 36a is thus projecting into the aperture 26a and at least partially disposed in the cavity 28a.

FIG. 6 is a second partial cross-sectional view of an embodiment of the broader invention assembled to a structure to be heated. A heater 12b is mounted with respect to a structure 36b. A thermal fluid, referenced schematically at 56b, is passing through the heater 12b. A gasket 22b is disposed between the heater 12b and the structure 36b. A cavity 28b is defined by and between the structure 36b, the gasket 22b, and the heater 12b. The cavity 28b is filled with a cured and solid heat transfer material referenced at 50b.

The structure 36b has a non-planar surface 52b contacting the heat transfer material 50b. The surface 52b defines a recess 54b. The recess 54b is at least partially filled during the step of locating the heater 12b, the gasket 22b, and the uncured quantity of heat transfer material. In this embodiment, the cavity 28b was over-filled with the uncured quantity of heat transfer material.

FIG. 7 is a third partial cross-sectional view of another arrangement. A heater 12c is mounted with respect to a structure 36c. A thermal fluid, referenced schematically at 56c, is passing through the heater 12c. A gasket 22c is disposed between the heater 12c and the structure 36c. A cavity 28c is defined by and between the structure 36c, the gasket 22c, and the heater 12c. The cavity 28c is filled with a cured and solid heat transfer material referenced at 50c.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Further, the “invention” as that term is used in this document is what is claimed in the claims of this document. The right to claim elements and/or sub-combinations that are disclosed herein as other inventions in other patent documents is hereby unconditionally reserved.

What is claimed is:

1. A heat transfer unit comprising:
a heater;
a gasket sealingly engaged with said heater along a first perimeter, said gasket including an aperture defining a cavity at least partially surrounded by said first perimeter and partially enclosed by said heater; and
a quantity of heat transfer material positioned in said cavity, said quantity being dispensed in liquid form into said cavity and curable to solidify while disposed in said cavity.

2. The heat transfer unit of claim 1 wherein said gasket is further defined as being formed of neoprene.

3. The heat transfer unit of claim 1 wherein said gasket is further defined as being adjustable.

4. The heat transfer unit of claim 1 wherein said heater further comprises:
a manifold having an inlet and an outlet, said inlet and said outlet in fluid communication with one another such that a thermal fluid can enter said manifold through said inlet and exit said manifold through said outlet.

5. The heat transfer unit of claim 4 wherein said manifold further comprises:
a torturous path extending between said inlet and said outlet.

6. The heat transfer unit of claim 1 further comprising:
a structure sealingly engaged with said gasket along a second perimeter, wherein said first perimeter and said second perimeter are on opposite sides of said gasket.

7. The heat transfer unit of claim 6 wherein said structure is further defined as projecting into said aperture and at least partially disposed in said cavity.

8. The heat transfer unit of claim 7 wherein said cavity is filled with said structure and said quantity of heat transfer material and without void.

9. The heat transfer unit of claim 8 wherein said gasket is at least partially elastically compressed between said structure and said heater.

10. A kit for a heat transfer unit comprising:
a heater;
a gasket operable to sealingly engage said heater along a first perimeter, said gasket including an aperture defining a cavity at least partially surrounded by said first perimeter and partially enclosed by said heater; and
a quantity of heat transfer material positionable in said cavity, said quantity being dispensable in liquid form into said cavity and curable to solidify while disposed in said cavity.

11. The kit of claim 10 further comprising:
a plurality of fasteners operable to mount said manifold and said gasket with respect to a structure to be heated.

12. The kit of claim 10 further comprising:
at least one plate having apertures to respectively receive said plurality of fasteners and operable to support said heater and said gasket.

13. The kit of claim 10 wherein said heater has a plurality of inlets and outlets.

14. A method of using the heat transfer unit kit of claim 9 comprising the steps of:
positioning said gasket on said heater such that said gasket and said heater sealingly engage one another along said first perimeter and said cavity is formed;
dispensing said quantity of heat transfer material in said cavity; and
curing said quantity of heat transfer material in said cavity.

15. The method of claim 14 further comprising the step of:
locating, between said dispensing step and said curing step, said heater and said gasket and said quantity of heat transfer material against a structure to be heated.

16. The method of claim 15 wherein said locating step is further defined as:
locating, between said dispensing step and said curing step, said heater and said gasket and said quantity of heat transfer material against a non-planar surface of the structure to be heated.

17. The method of claim 16 further comprising the step of:
inserting a protuberance projecting from said non-planar surface into said cavity during said locating step.

18. The method of claim 16 wherein:
said dispensing step is further defined as dispensing said quantity of heat transfer material in said cavity to overfill the cavity; and
said method further comprises the step of at least partially filling a recess in said non-planar surface with said quantity of heat transfer material during said locating step.

19. The method of claim 16 further comprising the steps of:
removing a first set of fasteners connecting the structure to a frame;
connecting, after said removing step, the structure and said heater and said gasket and said quantity of heat transfer material to the frame with a second set of fasteners.

20. The method of claim 19 further comprising the steps of:
connecting fluid lines to said heater after said connecting step.
